(19) United States
(12) Patent Application Publication
(10) Pub. No.: US 2026/0294169 A1
(43) Pub. Date: Oct. 1, 2026

(54) FRYER FILTER PUMP PROTECTION WITH MULTI-SPEED FILTRATION AND TOP OFF

(71) Applicant: FRYMASTER LLC.

(72) Inventors: Henry Preston Hutson, JR., Bossier City, LA (US); William Adamez, Kilgore, TX (US); Jan Claesson, Land O'Lakes, FL (US); Austin Haddock, Shreveport, LA (US)

(73) Assignee: FRYMASTER LLC., (omitted)

(21) Appl. No.: 19/351,614

(22) Filed: Oct. 7, 2025

Related U.S. Application Data
(60) Provisional application No. 63/704,374, filed on Oct. 7, 2024.

(51) Int. Cl. A47J 37/12; H02P 27/04

(52) U.S. Cl. CPC A47J 37/1223; A47J 37/1266; A47J 37/1285; H02P 27/045

(57) ABSTRACT

The fryer of the present disclosure has a pump that can be controlled to operate at varying speeds during filtration and top-off operations. The pump can be in communication with a variable speed motor and drive, such as a variable frequency drive (VFD). Any component that is capable of controlling and adjusting the amount of power delivered to the pump motor is suitable. A controller in the fryer monitors the output of the VFD, and controls the speed of the pump via the VFD. The speed of the pump can be varied throughout each operation. The speed of the pump can be low during a pressurization of a manifold, or comparatively high when a frypot is being filled. The controller can also control the pump to operate in a reverse direction, which pulls residual oil out of a conduit and the manifold after the filtration or top-off is complete. In one embodiment, there is only one pump in the fryer.

### CROSS-REFERENCE TO RELATED APPLICATION

The present application claims the benefit under 35 U.S.C. § 119 of U.S. Provisional Patent Application Ser. No. 63/704,374, filed on Oct. 7, 2024, which is herein incorporated by reference.

### BACKGROUND OF THE DISCLOSURE

### 1. Field of the Disclosure

The present disclosure relates to filtration and automatic top off (ATO) for fryer systems. More particularly, the present disclosure relates to filtration and ATO processes for cleaning and replacing oil in a frypot respectively, where the speed of the pump is monitored and controlled to operate at different speeds in each process.

### 2. Discussion of the Related Art

Users in fryer systems of commercial applications need to filter used cooking oil to remove solid food particles therefrom, as filtration extends the usable life of the oil. There are also instances where a frypot in use does not need to be filled completely, but only needs a top-off of fresh oil. Currently available systems do not offer significant control of these processes. There is typically one pump to use during a filtration and refill process, and a second pump to handle top-off processes. Further, these pumps can only be used at a single speed, which makes customization of filtration and top-off impossible.

### SUMMARY OF THE DISCLOSURE

The fryer of the present disclosure provides one single pump that can be controlled with a variable speed motor and drive, such as a variable-frequency drive (VFD), or any other device that can monitor and control the amount of power being supplied to a pump. The controller of the fryer will change the speed of the pump via the VFD during various points in filtration and top-off processes. Varying the speed of the pump in this way can allow for tight control and improvements in the processes. As two non-limiting examples, the controller of the present disclosure can operate the pump at a low speed to pressurize an oil distribution manifold early in a filtration process, which will help blow out any residue in the manifold. In another example, the controller can operate the pump at a high speed when filling an empty frypot with cooking oil, but at a low speed during a top-off, when only a small quantity of oil may need to be added to that frypot. This level of control is not available in current systems, nor is being able to accomplish all of these objectives with a single pump. In one embodiment, no other pumps are used in the fryer of the present disclosure. However, the present disclosure also contemplates using multiple pumps.

Accordingly, in one embodiment, the present disclosure comprises a fryer, comprising: a pump; a frypot; an oil distribution manifold; a filter pan; a conduit connecting the pump, wherein the oil distribution manifold, the frypot, and the filter pan are in fluid communication; a controller, wherein the controller controls the pump to move cooking oil through the conduit; and a variable speed motor or drive in communication with the controller and the pump. The controller is configured to place the fryer in a filtration mode and/or an automatic top-off mode, wherein the controller varies the speed of the pump via the variable speed motor or drive during the filtration mode and/or the automatic top-off mode.

In another embodiment, the present disclosure provides a process of filtering oil in a fryer, wherein the fryer comprises: a pump; a frypot having oil therein; an oil distribution manifold; a return valve between the oil distribution manifold and the frypot; a filter pan; a drain valve between the frypot and the filter pan; and a conduit connecting the pump, the oil distribution manifold, the return valve, the frypot, the drain valve, and the filter pan in fluid communication. The method comprises the steps of: initiating the filtration process; operating the pump to operate at a first speed while controlling the return valve to be in a closed position, so that the manifold is pressurized with air; controlling the return valve to open, so that the pressurized air passes from the manifold into the frypot and through the oil in the frypot; and controlling the pump to operate at a second speed during the prior controlling step, wherein the second speed is greater than or equal to the first speed.

In another embodiment, the present disclosure provides a process of topping off oil in a fryer, wherein the fryer comprises: a pump; a frypot having oil therein; a probe in the frypot; an oil distribution manifold; a return valve between the oil distribution manifold and the frypot; a filter pan; a drain valve between the frypot and the filter pan; and a conduit connecting the pump, the oil distribution manifold, the return valve, the frypot, the drain valve, and the filter pan in fluid communication. The method comprises the steps of: initiating the a top-off mode; operating the pump to operate at a first speed while controlling the return valve to be in a closed position, so that the manifold is pressurized with air; controlling the return valve to open, so that the pressurized air passes from the manifold into the frypot and through the oil in the frypot; controlling the pump to move oil through the conduit, and through the manifold and into the frypot; and controlling the pump to operate at a second speed during the prior controlling step, wherein the second speed is less than the first speed. When a level of oil in the frypot reaches the probe, the method further comprises controlling the pump to stop, and controlling the return valve to close.

### BRIEF DESCRIPTION OF THE FIGURES

FIG. 1 shows a schematic drawing of a fryer of the present disclosure.

FIGS. 2a and 2b show a cross-sectional view of two frypots according to the present disclosure.

FIGS. 2c, 2d, 2e, and 2f show frypots of the present disclosure in varying states of oil fill.

FIG. 3 shows a flow chart of a filtration process according to the present disclosure.

FIG. 4 shows a flow chart of an automatic top-off process according to the present disclosure.

### DETAILED DESCRIPTION OF THE DISCLOSURE

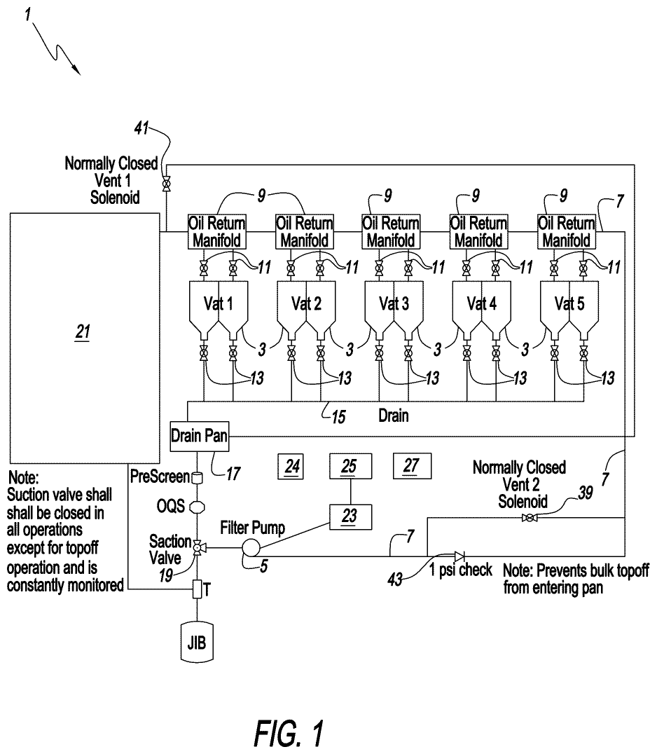

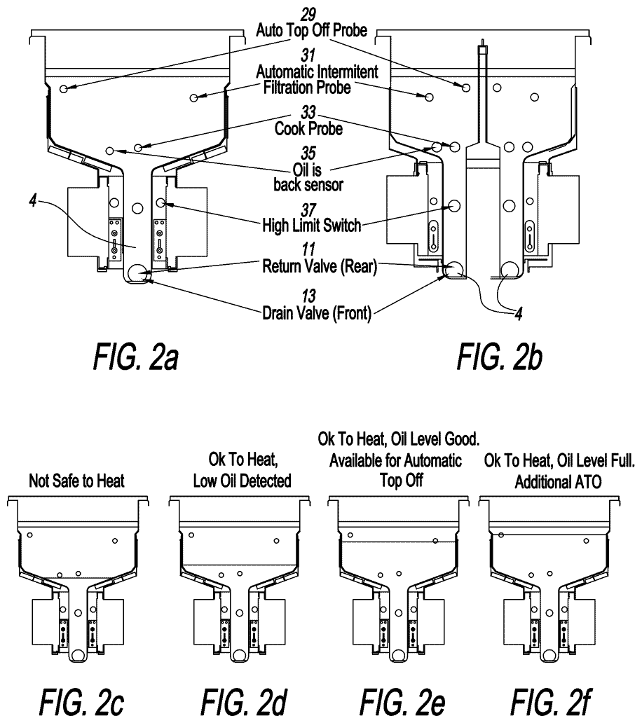

Referring to the drawings, and in particular FIG. 1, fryer system 1 of the present disclosure is shown. System 1 can have a plurality of frypots 3. In the shown embodiment, there are five frypots 3, which are each divided into two separate cooking zones (see FIG. 2b and the discussion below). Frypots 3 can have one large cooking area (as in FIG. 2a), or can be multi-zoned and divided frypots (FIG. 2b). Frypots can also be a mixture of each kind. e.g. that one frypot 3 is single-zone, and a second frypot 3 is multi-zone. A pump 5 drives air and a fluid such as cooking oil through return conduit 7, and into manifold 9, after which the air or fluid is dispersed into frypots 3. The frypots 3 are heated and food products are cooked in the cooking oil within frypots 3.

Each of the frypots 3 has one or more return valves 11 and one or more drain valves 13 associated therewith. In the shown embodiment, there are two return valves 11 and two drain valves 13 associated with each of the frypots. The return valves 11 are between the frypots 3 and manifold 9. Opening return valves 11 allows cooking oil to pass from manifold 9 into frypots 3.

The oil in frypot 3 will pick up solid food particles during a cooking process. These food particles need to be filtered out before the oil can be reused. The drain valves 13 are below or at a bottom end of frypots 3. Opening drain valves 13 allows used cooking oil to pass through drain conduit 15 and into filter pan or drain pan 17. Pump 5 helps to drive the used oil through filter pan 17 via suction. A suction valve 19 is in conduit 7 between filter pan 17 and pump 5. System 1 can also have a bulk oil delivery system 21 that also delivers oil to frypots 3.

System 1 also has variable frequency drive (VFD) 23, system control board (SCB) 25, and user interface (UI) 27. VFD 23 is in communication with pump 5. SCB 25 is in communication with VFD 23, UI 27, all of frypots 3, all of the return valves 11, all of drain valves 13, and suction valve 19, among other components. SCB 25 can also be in communication with a heater control board (not shown) that controls heaters (not shown) to heat the oil in frypots 3. For ease of description, the present embodiments are described with a VFD. However, the present disclosure contemplates any variable speed motor or drive that can vary the power and speed of pump 5.

SCB 25 controls all filtration events while UI 27 displays the actions a user can take and allows a user to initiate and control the various processes and functions. Advantageously, according to the present disclosure, during filtration events SCB 25 communicates with VFD 23 to analyze the current draw of the motor of pump 5 when it is in use. SCB 25 controls, through VFD 23, the motor of pump 5 to operate at different speeds. In the manner described in detail below, fryer system 1 thus provides variable speed filtration for improved washing of frypots 3, extended oil life, and reversing filter pump action to prevent contamination, for both filtering and automatic top-off operations. These features, in particular a single pump that can handle filtering and automatic top-off with variable speed operation, are not available in current systems, where pumps operate at uniform speeds. Fryer system 1 achieves this with several features and operations, including but not limited to pressurizing manifold 9 to avoid back flushing of solid particles that can clog manifold 9, variable speeds for pump 5 to flush the sediment out of the bottom of frypots 3, and the reversing of the pump 5 (in coordination of solenoids), to eliminate residual oil in manifold 9 to avoid the problem of solid oil in the system conduits and overfilling opposing fryers. As previously noted, the present disclosure contemplates that multiple pumps can be used.

Currently available fryer systems do not have the ability to conduct all of these operations. In current systems, the pumps operate at uniform speeds. This makes it difficult to achieve all of the objectives in a filtration process, such as pressurizing the manifold, agitating oil in the frypot before draining, suctioning oil back out of the conduit after refilling of the frypot is complete, washing sediment out of the frypot during or before draining it, and preventing bubbling or splashing of oil in the frypot to protect the operator and preserve oil life. A pump motor operating at a single speed might be too fast or too slow to achieve at least some if not all of these objectives. For example, if a pump motor is set at a relatively high speed to fill a frypot with cooking oil quickly, this may be too fast a speed to pressurize the manifold. By varying the speed of pump 5, SCB 25 of the present disclosure can achieve all of the goals described above. Current systems certainly do not have the ability to perform these operations with a single pump, as is possible in one embodiment of the present disclosure.

One other significant advantage of fryer system 1 is the suction operation discussed below, which takes place after frypots 3 are refilled with filtered oil. In current systems, some oil will remain in the conduits that carry oil to frypots. The oil will solidify within the conduit at room temperature, which would prevent or at least greatly hamper a subsequent refilling operation. To address this, many current systems use heater tape or some other warmer on the conduit carrying the oil, to keep it in a liquid state. The present disclosure eliminates the need for a heater or heater tape on the oil conduit, since during the suction operation discussed below a significant amount of oil is removed from conduit 7 after refilling frypots 3. SCB 25 can control pump 5 to remove most if not all of the oil in conduit 7 after the refilling of frypots 3 is complete. The present inventors have discovered that clearing at least 30% of the oil within conduit 7 during a suction operation will allow subsequent filling operations to run smoothly.

Referring to FIG. 2a-2f, frypots 3 of the present disclosure are shown at various levels of cooking oil. FIG. 2s shows a frypot 3 with one single large cooking vat, and FIG. 2b shows a frypot 3 with the cooking vat divided into two distinct cooking zones. Frypots 3 can have a shape that is wide at a top end and then narrows to a vertical channel 4. This shape can be advantageous for removing used cooking oil and sediment.

FIGS. 2a and 2b show the location of several probes and sensors that are connected to frypots 3. From top to bottom, these are automatic top-off (ATO) probe 29, automatic intermittent filtration (AIF) probe 31, cook probe 33, oil is back (OIB) sensor 35, and high limit switch 37. ATO probe 29 is at the highest permissible level for oil in frypot 3. AIF probe 31 is at a lower level than ATO probe 29, and detects when the level of oil in frypot 3 is sufficient for filtration. Cook probe 33 is lower than AIF probe 31, near a point at which frypot 3 narrows to channel 4. Cook probe 33 detects the temperature of frypot 3). OIB sensor 35 can be slightly lower than cook probe 33, as shown, or may be in another location in frypot 3. OIB sensor 35 determines a level at which oil has returned to frypot 3 (for example filled channel 4), and when frypot 3 is safe to heat. Each of AIF probe 31, cook probe 33, OIB sensor 35, and high limit switch 37 are in communication with heater control board 24, which in turn is in communication with SCB 25. High limit switch 37 is a required safety switch that kills power to heating when it detects that frypot 3 is above a certain temperature.

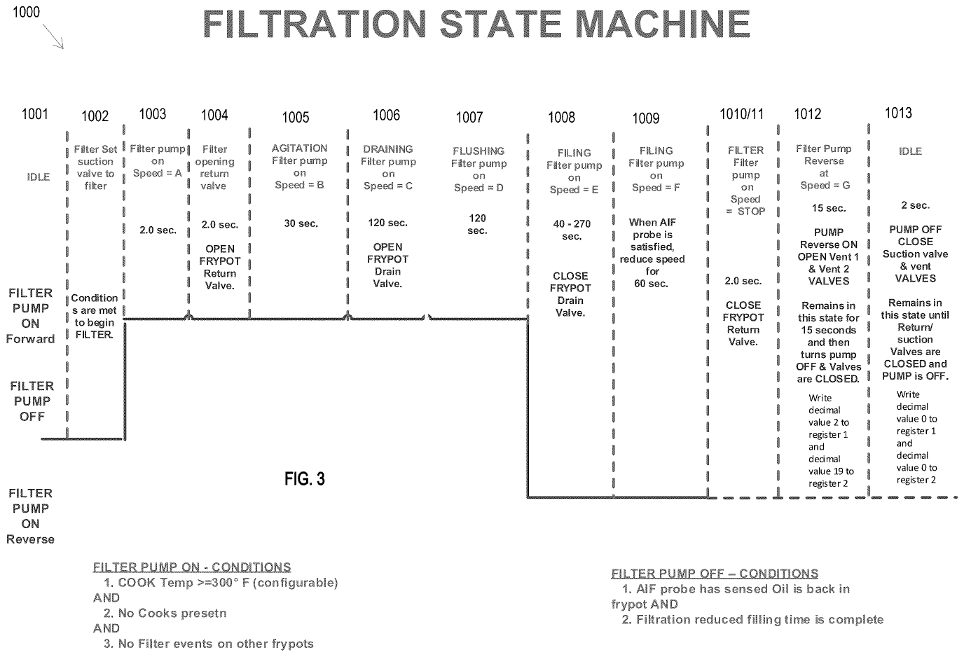

In FIG. 2c, the oil in frypot 3 is only high enough to reach OIB sensor 35. In this state, HCB 24 will know that the oil level is too low for safe heating of the oil. In FIG. 2d, the oil level is high enough that OIB sensor 35 and cook probe 33 are activated. In this state, HCB 24 will know that the oil is safe to heat, but is still too low for cooking. In FIG. 2e, the oil level is high enough so that each of AIF probe 31, cook probe 33, and OIB sensor 35 are activated. In this state, HCB 24 will know that there is enough oil in frypot 3 so that it is safe to heat, the level is sufficient for cooking, and that the oil can still receive a top-off. In FIG. 2f, ATO probe 29 is activated in addition to the sensors and probes from FIG. 3. In this condition, SCB 25 knows that the oil is safe to heat, at a sufficient level for cooking, and cannot receive a top-off. The sensors and probes of FIGS. 2a-2f can be utilized in the filtration and ATO processes discussed in detail below.

Referring to FIG. 3, a flow chart of a filtration process 1000 is shown. An operator initiates a filtration event in one of frypots 3 (step 1001), for example by selecting an option on UI 27. Each of frypots 3 can be filtered independently of other frypots 3. SCB 25 will first ensure that suction valve 19 is in a first position to allow filtering (step 1002). This closes off other components of fryer system 1 (such as bulk oil system 21 and a jug-in-box or JIB) that are not needed for filtration. SCB 25 then controls pump 5, via VFD 23, to operate at a first speed A (step 1003). This pressurizes manifold 9 with air, as return valve 11 has not yet been opened (nor has drain valve 13). SCB 25 then opens return valve 11 (step 1004). The air pressure buildup in manifold 9 helps to remove any sediment in manifold 9 when return valve 13 is opened. The pump speed is at A for each of steps 1003 and 1004. In one embodiment, speed A can be less than half of the maximum speed for pump 5.

SCB 25 then controls the fryer system to enter an agitation mode (step 1005), where the pump speed is set to a value B, which is greater than or equal to speed A. The agitation step helps the oil to flush sediment out of frypot 3. Return valve 11 is still open during step 1005. Forcing pressurized air through the used oil in frypot 3 causes bubbling and agitation of the oil. This assists in moving any sediment in the used oil to the bottom of frypot 3 and into channel 4.

When the agitation of step 1005 ends, SCB 25 then controls drain valve 13 to open (step 1006). In step 1006, the SCB controls the filter pump speed to increase slightly to a value C, which is greater than speeds A and B. This lightly flushes sediment out of frypot 3 with pressurized air. When the used oil is drained, the SCB controls the speed of pump 5 to be at a value D, which is greater than values A, B, and C (step 1007). This flushes the bottom of frypot 3 by removing sediment, with oil that has returned from filter pan 13.

When the flushing sequence ends, SCB 25 closes drain valve 13 and increases the speed of pump 5 to a value E, which is greater than A, B, C, and D, and near or at the maximum speed of pump 5 (step 1008). At this highest value E, frypot 3 is being filled comparatively quickly with filtered oil returning from filter pan 17, through conduit 7 to manifold 9, and through return valves 11 into frypot 3. When SCB 25 senses that the oil in frypot 3 has reached the level of AIF probe 31 via HCB 24 (step 1009), it reduces the speed of pump to a value F, which is lower than E. This reduction in speed helps to reduce bubbling of the oil and splashing of oil out of frypot 3. Pump 5 can continue to add oil to frypot 3 while running at speed F, until a desired amount of oil is in frypot 3—for example, the amount of oil that was in frypot 3 before filtration began. After this, SCB closes return valve 11 (step 1010) and stops pump 3 for a period of time (step 1011).

After step 1010 is completed, frypot 3 has been filled with filtered oil to a level sufficient for cooking and the filtration process of frypot 3 has been completed. However, the present disclosure advantageously provides additional pump control. At this point, SCB 25 controls a bypass solenoid 39 and an air solenoid 41 to open. Further, SCB 25 controls pump 5 to operate at a reverse speed G (step 1012). Solenoids 39 and 41 are in line of conduit 7. Opening air solenoid 41 and bypass solenoid 39 is needed for the reverse speed operation, as air solenoid introduces air 41 into the system to allow the fluid remaining in the filtration lines to be pumped backwards. Opening bypass solenoid 39 allows the cooking oil to bypass the top-off check valves 43 in the system and return the cooking oil to the proper location.

Operating pump 5 at reverse speed G helps to remove residual oil from the plumbing system, specifically from conduit 7 and manifold 9. This prevents cross-contamination of the oils and reduces overfilling of frypot 3. Without this reverse flow, some oil will remain in conduit 7 and/or manifold 9, and be added to frypot 3 during the next filling cycle, which can lead to overfilling. In addition, if the oil left in conduit 7 and manifold 9 is designated for one type of food (e.g. spicy food), and frypot 3 is subsequently used to cook a different kind of food product (e.g. sweet or neutral), there is a risk that the flavor of the second food will be adversely affected. The present disclosure addresses this concern. The oil removed during reverse step 1012 can be returned to filter pan 13 to a jug-in-box (JIB). Finally, after oil has been removed from conduit 7 and manifold 9 via reverse flow, SCB 25 turns off pump 5 and closes all valves in system 1 (step 1013).

As extra precautionary measures and safeguards, fryer system 1 and SCB 25 can be configured so that several conditions at the beginning and end of process 1000 must be met. As shown in FIG. 1, before beginning filtration process 1000, SCB 25 can ensure that the following conditions are met: the cooking temperature in frypot 3 should be greater than or equal to 300 degrees Fahrenheit (this is configurable); there are no other cooking operations in any of the other frypots 3 of fryer system 1; and there are no filtrations in other frypots 3 taking place. SCB 25 will also not turn off pump 5 (step 1011) unless the level of oil has reached AIF probe 31, and that a certain amount of time has passed, indicating that frypot 3 is full of filtered oil.

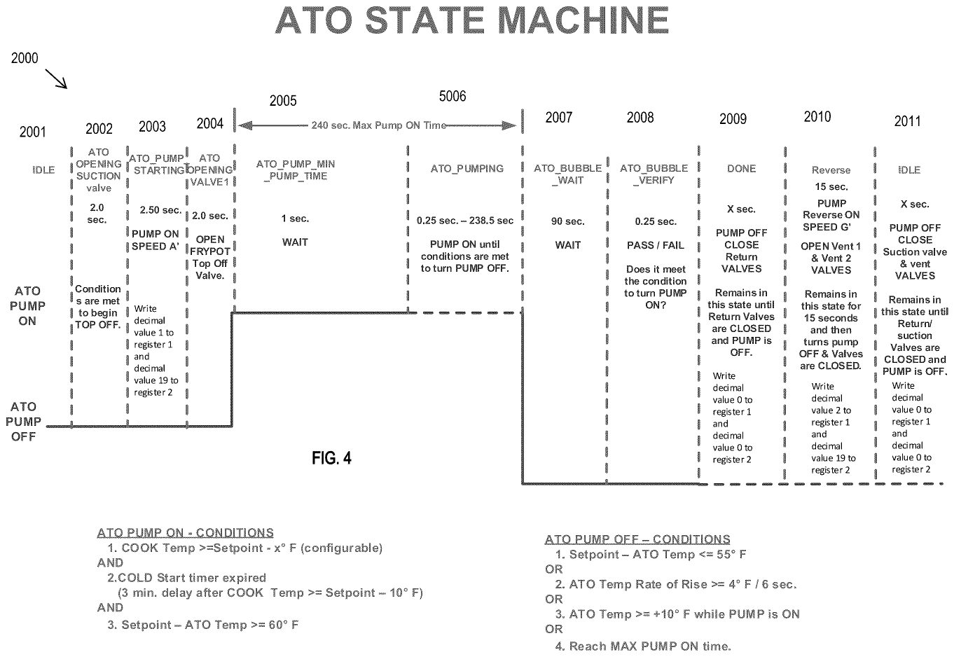

Referring to FIG. 4, a flow chart of an automatic top-off (ATO) process 2000 is shown. Process 2000 can run when there is a significant amount of oil in frypot 3, for example up to the level of AIF probe 31, but additional oil is needed for optimal cooking. Process 2000 can begin automatically, or upon initiation by a user (step 2001). SCB 25 controls suction valve 19 to a second position, namely a top-off position (step 2002), which blocks off components of fryer 1 that are not needed for process 2000. SCB 25 then controls pump 5 to operate at a speed A′ (step 2003), which like speed A of process 1000, can be less than half of a maximum speed of pump 5. This forces pressurized air into manifold 9. After a period of time, SCB opens return valve 11 (step 2004), which removes sediment from manifold 9. SCB 25 then controls pump 5 top operate at a speed B′, which can be lower than speed A′. This low speed is desirable because during a top-off operation, there is a comparatively low volume of oil being added to frypot 3, and tight control of the volume is needed. Again, in currently available systems, this flexibility is not possible. Current systems will usually need at least two separate pumps, one for filtration and filling operations, and another for top-off. Fryer system 1 of the present disclosure eliminates this need. SCB 25 continues the flow of oil into frypot until ATO probe 29 is triggered.

Pump time step 2005, ATO pumping step 2006, ATO bubble wait step 2007, ATO bubble verify step 2008, and Done step 2009 are the same as disclosed in United States Patent Application Publication No. 2015/0272390, filed Mar. 28, 2014, which is incorporated herein by reference, in particular processes 300 and 300A of FIGS. 9 and 12 respectively, and the accompanying disclosure. The '390 Publication also discusses the ATO pump on and pump off conditions shown in FIG. 4 of the present application.

After step 2009, the ATO of frypot 3 has been completed. However, as in process 1000, the present disclosure advantageously provides a way to remove residual oil from conduit 7 and manifold 9. At this point, SCB 25 controls bypass solenoid 39 and air solenoid 41 to open. Further, SCB 25 controls pump 5 to operate at a reverse speed G′ (step 2010). As previously discussed with process 1000, operating pump 5 at reverse speed G′ helps to remove residual oil from the plumbing system, specifically from conduit 7 and manifold 9. Finally, after oil has been removed from conduit 7 and manifold 9 via reverse flow, SCB 25 turns off pump 5 and closes all valves in system 1 (step 2011).

The pump speeds A, B, C, D, E, F, G, A′, B′, and G′ will vary, and will depend upon the parameters and conditions of the fryer system. The present disclosure is not limited to any particular pump speeds in process 1000 and 2000. What is important is that these values vary and are controllable. Further, how the speeds vary and compare to one another (e.g. B is slightly greater than or equal to A, D is significantly greater than A, B, and C) is an improvement provided by the present disclosure and not found in current systems. In an embodiment of the present disclosure, all of the disclosed speeds can be different, or some may be equal to one another where discussed above.

In one non-limiting embodiment, A, A′, B, and B′ are less than 50% of the maximum speed M of pump 5. A, A′, and B, or 25% of M, or any subranges of 25% to less than 50% of M. B′ can be 15% of M, or any subranges of 15% to less than 50% of M. C is also less than 50% of M, or 35% of M, or any subranges of 35% to less than 50% of M. D is greater than 50% of M, or 70% of M, or any subranges of 50% to 70% of M. E is 90% or M or greater, or 100% of M. F is less than 50% of M, or 40% of M, or any subranges of 40% to less than 50% of M. G and G′ are less than 50% of M, or 30% of M, or any subranges of 30% to less than 50% of M. For the specific percentage values of these speeds, the present disclosure contemplates that the speed can be +/−10% of M and any subranges therebetween, or +/−5% of M and any subranges therebetween. For example, speeds A, A′, B, and B′ can be from 15% of M to 35% of M and any subranges therebetween, or 20% of M to 30% of M and any subranges therebetween.

The times of each of the steps of processes 1000 and 2000 are shown in FIGS. 3 and 4. The present disclosure contemplates that the time interval can be +/−50% of the interval shown and any subranges therebetween, or +/−25% of the interval shown, and any subranges therebetween. For example, for step 1003 of process 1000, the pressurizing of manifold 9, the time can be from 1.0 seconds to 3.0 seconds, and any subranges therebetween, or from 1.5 seconds to 2.5 seconds, and any subranges therebetween. For step 1007, the flushing of frypot 3, the time can be from 60 seconds to 180 seconds, and any subranges therebetween, or from 90 seconds to 150 seconds, and any subranges therebetween.

The motor for pump 5 can be a multi-phase motor, such as a three-phase motor, as they can be more suitable for the heavy loads of industrial applications. However, the present disclosure also contemplates that the motor for pump 5 can be a single-phase motor, or a DC motor. Further, as an alternative to VFD 23, any device or method that monitors and communicates the current or power draw of a motor can be used.

As outlined in the present disclosure, fryer 1 provides several advantages not found in current fryers. These include, but are not limited to, the use of a single pump 5, pressurizing and evacuating manifold 9 during a filtration or top-off operations, varying the speed of pump 5 through various stages of filtration and top-off processes, and reversing pump 5 to remove residual oil from conduit 7 and/or manifold 9. The features disclosed herein can be used for gas or electric fryers.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A fryer, comprising:
a pump;
a frypot;
an oil distribution manifold;
a filter pan;
a conduit connecting the pump, wherein the oil distribution manifold, the frypot, and the filter pan are in fluid communication;
a controller, wherein the controller controls the pump to move cooking oil through the conduit; and
a variable speed motor or drive in communication with the controller and the pump,
wherein the controller is configured to place the fryer in a filtration mode and/or an automatic top-off mode, wherein the controller varies the speed of the pump via the variable speed motor or drive during the filtration mode and/or the automatic top-off mode.

2. The fryer of claim 1, further comprising a return valve between the oil distribution manifold and the frypot, wherein the controller controls the return valve to move between a first position and a second position to allow oil to pass into the frypot and prevent oil from passing into the frypot, respectively.

3. The fryer of claim 1, further comprising a drain valve between the frypot and the filter pan, wherein the controller controls the drain valve to move between a first position and a second position to allow oil to pass into the filter pan and prevent oil from passing into the filter pan, respectively.

4. The fryer of claim 1, wherein there is one, single pump in the fryer.

5. The fryer of claim 1, further comprising a filtration probe in the frypot, and the controller is configured to end the filtration mode when a level of oil in the frypot reaches the filtration probe.

6. The fryer of claim 1, further comprising a top-off probe in the frypot, and the controller is configured to end the top-off mode when a level of oil in the frypot reaches the top-off probe.

8. The fryer of claim 1, further comprising a solenoid valve between the pump and the manifold along the conduit, wherein during a reverse mode, the controller controls the pump to open the solenoid valve and pull oil in a direction away from the manifold.

9. A process of filtering oil in a fryer, wherein the fryer comprises:
a pump;
a frypot having oil therein;
an oil distribution manifold;
a return valve between the oil distribution manifold and the frypot;
a filter pan;
a drain valve between the frypot and the filter pan; and
a conduit connecting the pump, the oil distribution manifold, the return valve, the frypot, the drain valve, and the filter pan in fluid communication;
the method comprising the steps of:
initiating the filtration process;
operating the pump to operate at a first speed while controlling the return valve to be in a closed position, so that the manifold is pressurized with air;
controlling the return valve to open, so that the pressurized air passes from the manifold into the frypot and through the oil in the frypot; and
controlling the pump to operate at a second speed during the prior controlling step, wherein the second speed is greater than or equal to the first speed.

10. The method of claim 9, further comprising the steps of;
controlling the drain valve to open, so that oil passes from the frypot into the filter pan;
and controlling the pump to operate at a third speed during the prior controlling step, wherein the third speed is greater than the first speed and the second speed.

11. The method of claim 10, further comprising the step of:
controlling the pump to move oil from the filter pan and into the frypot while the drain valve is open, to flush sediment out of the frypot; and
controlling the pump to operate at a fourth speed during the prior controlling step, wherein the fourth speed is greater than the first speed, the second speed, and the third speed.

13. The method of claim 12, further comprising the steps of:
controlling the drain valve to close, preventing oil from passing from the frypot into the filter pan;
controlling the pump to move oil coming from the filter pan through conduit and the manifold, and into the frypot;
controlling the pump to operate at a fifth speed during the prior controlling the pump step wherein the fifth speed is greater than each of the first, second, third, and fourth speeds.

14. The method of claim 13, wherein the fryer comprises a filtration sensor in the frypot, and the method further comprising the step of:
when the level of oil in the frypot reaches the filtration sensor, controlling the pump to operate at a sixth speed, wherein the sixth speed is less than the fifth speed.

15. The method of claim 14, wherein the fryer comprises a top-off sensor in the frypot, wherein the top-off sensor is at a higher location in the frypot than the filtration sensor, the method further comprising the step of:
when the level of oil in the frypot reaches the top-off sensor, controlling the return valve to close, thereby preventing oil from entering the frypot from the manifold, and controlling the pump to stop.

16. The method of claim 15, wherein the fryer further comprises a vent valve in the conduit between the pump and the manifold, and the method further comprises the steps of:
controlling the vent valve to open;
controlling the pump to operate in reverse at a seventh speed, so that oil is pulled by the pump through the conduit in a direction away from the manifold.

17. The method of claim 10, wherein the pump has a maximum speed, and the first and second speeds are less than 50% of the maximum speed.

18. The method of claim 11, wherein the pump has a maximum speed, and the third speed is less than 50% of the maximum speed.

18. The method of claim 12, wherein the pump has a maximum speed, and the fourth speed is greater than 50% of the maximum speed.

19. The method of claim 13, wherein the pump has a maximum speed, and the fifth speed is 90% or greater of the maximum speed.

20. The method of claim 14, wherein the pump has a maximum speed, and the sixth speed is less than 50% of the maximum speed.

21. The method of claim 16, wherein the pump has a maximum speed, and the seventh speed is less than 50% of the maximum speed.

22. A process of topping off oil in a fryer, wherein the fryer comprises:
a single pump;
a frypot having oil therein;
a probe in the frypot;
an oil distribution manifold;
a return valve between the oil distribution manifold and the frypot;
a filter pan;
a drain valve between the frypot and the filter pan; and
a conduit connecting the pump, the oil distribution manifold, the return valve, the frypot, the drain valve, and the filter pan in fluid communication;
the method comprising the steps of:
initiating a top-off mode;
operating the pump to operate at a first speed while controlling the return valve to be in a closed position, so that the manifold is pressurized with air;
controlling the return valve to open, so that the pressurized air passes from the manifold into the frypot and through the oil in the frypot; and
controlling the pump to move oil through the conduit, and through the manifold and into the frypot;
controlling the pump to operate at a second speed during the controlling the pump step, wherein the second speed is less than the first speed;
wherein, when a level of oil in the frypot reaches the probe, controlling the pump to stop, and controlling the return valve to close.

23. The method of claim 22, wherein the fryer further comprises a vent valve in the conduit between the pump and the manifold, and the method further comprises the steps of:
controlling the vent valve to open;
controlling the pump to operate in reverse at a third speed, so that oil is pulled by the pump through the conduit in a direction away from the manifold.
